(19) United States
(12) Patent Application Publication
(10) Pub. No.: US 2015/0149127 A1
(43) Pub. Date: May 28, 2015

(54) Methods and Systems to Synthesize Road Elevations

(71) Applicant: Google Inc., (US)

(72) Inventors: Joshua Sam Schpok, Milpitas, CA (US); Tilman Reinhardt, Woodside, CA (US)

(73) Assignee: Google Inc., Mountain View, CA (US)

(21) Appl. No.: 13/657,284

(22) Filed: Oct. 22, 2012

Related U.S. Application Data
(60) Provisional application No. 61/656,217, filed on Jun. 6, 2012.

(51) Int. Cl. G06F 17/50; G06F 17/10

(52) U.S. Cl. CPC G06F 17/509
USPC 703/2

(57) ABSTRACT

Embodiments disclosed herein relate to synthesis of road elevation values. An embodiment includes traversing one or more road paths from a point in a road network model to identify intersections of the traversed road paths with terrain elevation values in an elevation model corresponding to the road network model, and interpolating an elevation value for the point using elevation values associated with the identified intersections, where the traversing and the interpolating are performed for each point on the road network model. In an embodiment, the interpolating can be performed when the point's elevation value is unavailable in the elevation model due to one or more non-terrain features overlapping the point and preventing measurement of the point's elevation value.

### CROSS REFERENCE TO RELATED APPLICATIONS

This application claims the benefit of U.S. Provisional Application No. 61/656,217, filed on Jun. 6, 2012, which is incorporated herein by reference in its entirety.

### BACKGROUND

1. Field

Embodiments generally relate to geographical terrain modeling.

2. Background Discussion

Digital mapping applications and three dimensional (3D) terrain viewing applications utilize satellite and aerial imaging techniques to measure terrain elevation values. The Earth's surface generally includes non-terrain objects (e.g., buildings, vegetation, etc.) that can often obscure bare Earth terrain as well as any roads and paths built on the terrain preventing measurement of elevation values of bare Earth terrain and the roads and paths. Accordingly, it is not possible to accurately measure elevation values of these obscured features using conventional techniques.

Digital mapping applications and 3D terrain viewing applications enable users to view satellite imagery superimposed over a two dimensional map or 3D globe. This feature and its associated rendering is commonly known as a ‘satellite’ view. In a satellite view, there can exist sharp and narrow features (e.g., roads) that are partially obscured by non-terrain objects (e.g., trees, vegetation, etc.). Because elevation values associated with these obscured features are unavailable, elevations and gradations of these terrain features are conventionally approximated as smooth surfaces following gradations of neighboring terrain. However, such approximations lead to rendered terrain having incorrectly elevated features. Particularly, when terrain along roads is synthesized along mountains and hillsides, a graded road surface is rendered that is inconsistent with a level road surface because the rendered road surface simply follows neighboring terrain gradation of the mountains and the hillsides. Such rendering artifacts degrade a user's viewing experience.

### BRIEF SUMMARY

Embodiments relate to synthesis of road elevation values. A method embodiment includes traversing one or more road paths from a point in a road network model to identify intersections of the traversed road paths with terrain elevation values in an elevation model corresponding to the road network model, and interpolating an elevation value for the point using elevation values associated with the identified intersections, where the traversing and the interpolating are performed for each point on the road network model.

The method embodiment further includes determining traversed distances from the point to each of the intersections and interpolating the elevation value for the point as a function of each of the traversed distances and the elevation values associated with the identified intersections to obtain an interpolated elevation value for the point, the interpolating performed when the point's elevation value is unavailable in the elevation model due to one or more non-terrain objects overlapping the point and preventing measurement of the point's elevation value.

In this way, by determining interpolated elevation values for points whose elevation values are unavailable in an elevation model, embodiments generate a complete elevation model that improves quality of rendered terrain features. Furthermore, such a complete interpolated elevation model can also be used to generate accurate routes (e.g., bicycle routes) where terrain gradation is a consideration.

Further embodiments, features, and advantages of the embodiments, as well as the structure and operation of the various embodiments are described in detail below with reference to accompanying drawings.

### BRIEF DESCRIPTION OF THE DRAWINGS

Embodiments are described with reference to the accompanying drawings. In the drawings, like reference numbers may indicate identical or functionally similar elements.

The drawing in which an element first appears is generally indicated by the left-most digit in the corresponding reference number.

FIG. 1 illustrates a system for synthesis of elevation values, according to an embodiment.

FIG. 2 illustrates a road traversal engine, according to an embodiment.

FIG. 3A is a diagram illustrating an exemplary road partially obscured by non-terrain objects.

FIG. 3B is a diagram illustrating an exemplary visualization of an elevation model, according to an embodiment.

FIG. 3C is a diagram illustrating an exemplary visualization of a road network in a road network model, according to an embodiment.

FIG. 3D is another diagram illustrating exemplary elevation values of FIG. 3B aligned with the road network of FIG. 3C, according to an embodiment.

FIG. 4A is a diagram illustrating exemplary elevation values in the elevation model of FIG. 3B that correspond to the road network of FIG. 3C, according to an embodiment.

FIG. 4B is a diagram illustrating an exemplary road elevated and rendered using the elevation values of FIG. 4A.

FIG. 5A is a diagram illustrating an output elevation model, including interpolated elevation values corresponding to the road network of FIG. 3C, according to an embodiment.

FIG. 5B is a diagram illustrating an exemplary road elevated and rendered using the elevation values of FIG. 5A, according to an embodiment.

FIG. 6 is a flowchart illustrating an exemplary overall operation, according to an embodiment.

FIG. 7 is a flowchart illustrating an exemplary interpolating operation, according to an embodiment.

FIG. 8 illustrates an example computer useful for implementing components of embodiments.

### DETAILED DESCRIPTION

Embodiments relate to synthesis of road elevation values. As noted above, embodiments interpolate a point's elevation value (e.g., elevation value of a point on a road), when the point's elevation value is unavailable in an elevation model due to one or more non-terrain features (e.g., vegetation) overlapping (or obscuring) the point and preventing measurement of the point's elevation value.

A method embodiment includes traversing one or more road paths from a point in a road network model to identify intersections of the traversed road paths with terrain elevation values in an elevation model corresponding to the road network model, and interpolating an elevation value for the point using elevation values associated with the identified intersections, where the traversing and the interpolating are performed for each point on the road network model.

The method embodiment further includes determining traversed distances from the point to each of the intersections. In an embodiment, an interpolated elevation value for the point is a function of each of the traversed distances and the elevation values associated with the identified intersections.

As noted above, the interpolating can be performed when the point's elevation value is unavailable in an elevation model due to one or more non-terrain features (e.g., vegetation) overlapping the point and preventing measurement of the point's elevation value.

In this way, by determining interpolated elevation values for points whose elevation values are unavailable, embodiments generate a complete elevation model that can be used to render appropriately elevated features (e.g., road networks) to improve user viewing experience. Furthermore, such a complete interpolated elevation model can also be used to generate accurate routes (e.g., bicycle routes) where terrain gradation is a consideration.

While the present embodiments are described herein with reference to illustrative applications, it should be understood that the embodiments are not limited thereto. Those skilled in the art with access to the teachings provided herein will recognize additional modifications, applications, and embodiments within the scope thereof and additional fields in which the embodiments would be of significant utility.

As used herein, the term “point” can refer to one point or even a group or locus of points forming a region. In a non-limiting embodiment, the point can be a pixel or even a group of pixels that may be rendered or displayed on screen.

As used herein the term “measured elevation value” refers to any elevation value that may be observed/measured using satellite, aerial and other techniques. As a non-limiting example, measurement of an elevation value may be prevented by one or more non-terrain objects obscuring a feature whose elevation is to be measured.

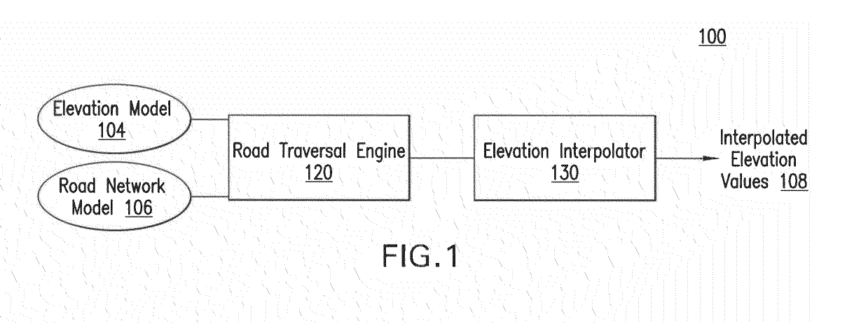

FIG. 1 is a diagram of system 100 for synthesis of road elevation values, according to an embodiment. While the following is described in terms of roads, paths, road networks, road points and road segments, the embodiments are not limited to such features and the techniques described herein can be applied to any other form of data, including, but not limited to, any terrain data, oceanic data, astronomical data, any non-terrain objects such as bridges and overpasses, or any combination thereof. The embodiments are applicable to any system having generally the structure of FIG. 1, or that would benefit from the operation, methods and functions as described herein.

System 100 includes road traversal engine 120 and elevation interpolator 130. In an embodiment, road traversal engine 120 receives (or retrieves from storage) elevation model 104 and road network model 106. In an embodiment, elevation interpolator 130 generates interpolated elevation values 108 using input from road traversal engine 120 as well as data from elevation model 104 and road network model 106.

In an embodiment, elevation model 104 can be a digital elevation model including elevation values of terrain representing the surface of the Earth. Such terrain can be, for example, ‘bare’ Earth terrain that does not include non-terrain objects (e.g., vegetation, buildings, etc.). In an embodiment, elevation model 104 can be any data structure storing one or more elevation values.

In an embodiment, elevation model 104 may be constructed using elevation values measured through satellite/aerial imaging and elevation measurement techniques. As illustrative example, elevation model 104 can include one or more elevation values of terrain, whose observation (or measurement) has not been obstructed by non-terrain objects (e.g., trees), and are thus considered to be accurate elevation values of the Earth's bare surface (or ‘good’ elevation values).

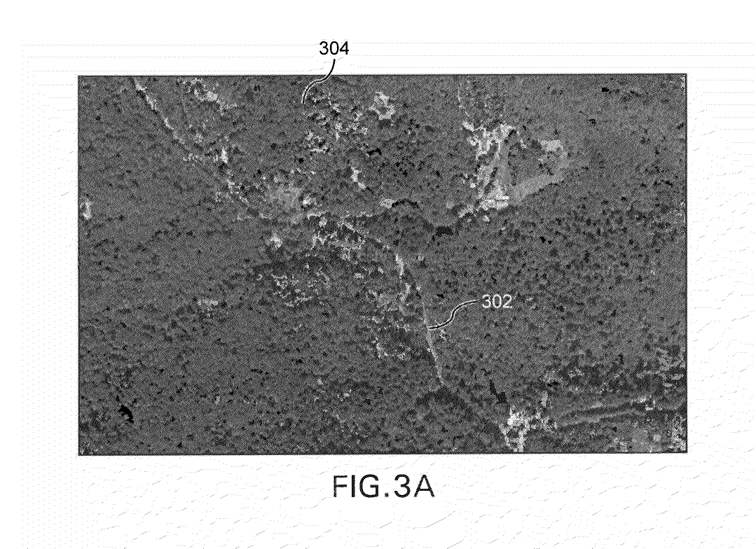

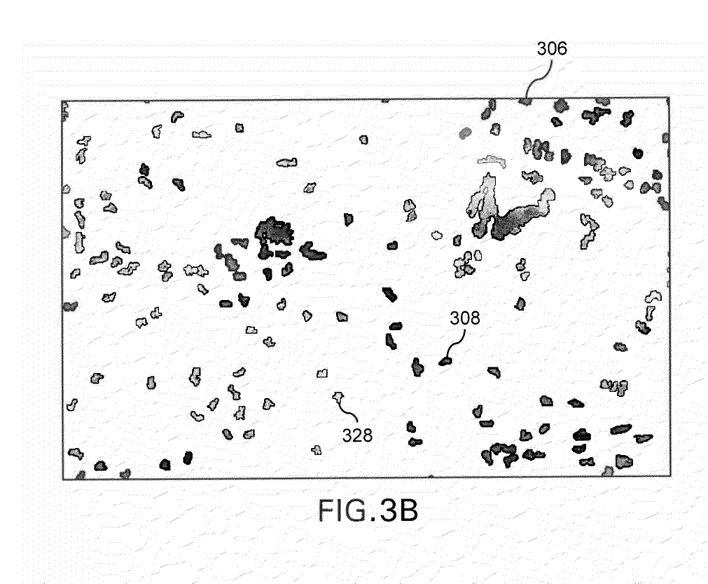

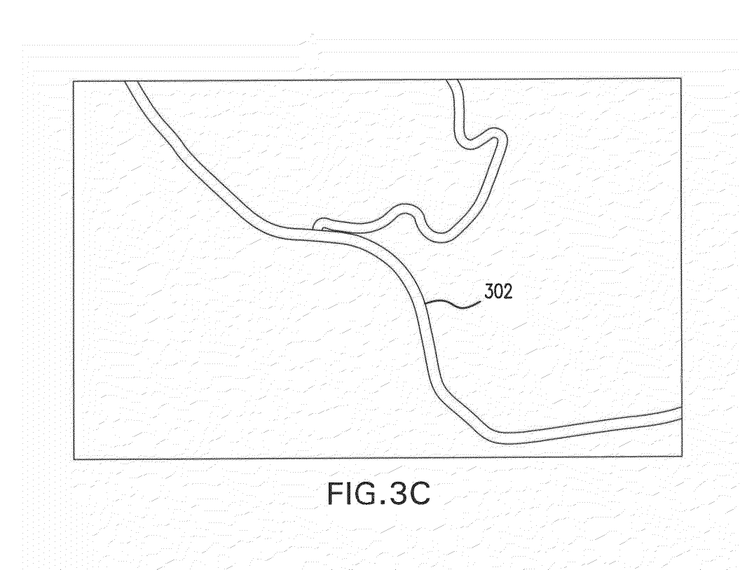

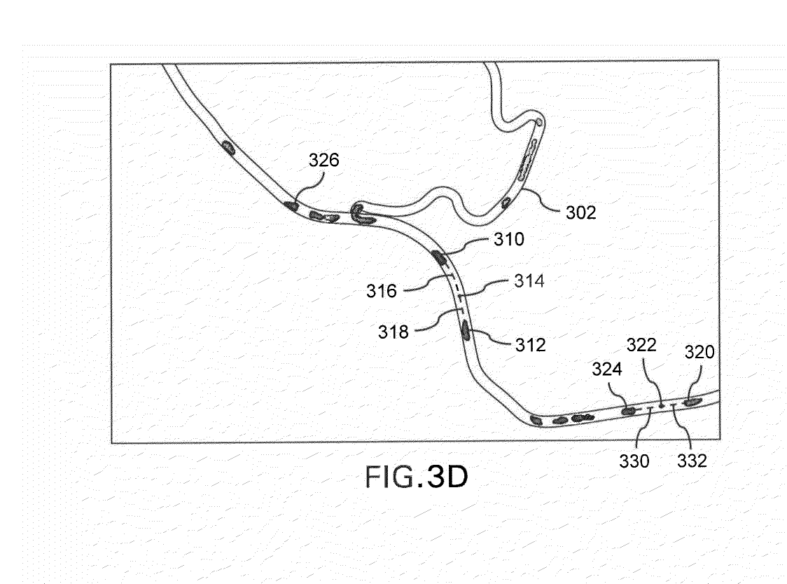

In an embodiment, elevation model 104 can be visually represented as an elevation map showing regions having measured bare Earth elevation values. FIG. 3B illustrates an exemplary visual representation 306 of elevation model 104, according to an embodiment. For example, referring to FIG. 3B, 308 and 328 represent measured bare Earth elevation values.

In an embodiment, road network model 106 includes data specifying locations (or co-ordinates) of any roads, paths, road segments and road networks in one or more geographical regions. In an embodiment, such road data may be stored and maintained as map data or vector data defining one or more road segments. FIG. 3C illustrates an exemplary visual representation of road network 302 in road network model 106, according to an embodiment.

In an embodiment, road traversal engine 120 is configured to receive (or retrieve from storage) elevation model 104 and road network model 106. In an embodiment, road traversal engine 120 is configured to traverse one or more road paths from a point in road network model 106 to identify intersections of the traversed paths with terrain elevation values in elevation model 104. In an embodiment, road traversal engine 120 identifies the intersections by aligning road network model 106 with elevation model 104 in order to determine a correspondence between road points in road network model 106 and elevation values in elevation model 104. Alignment performed by road traversal engine 120 is discussed further below.

In an embodiment, elevation interpolator 130 is configured to interpolate an elevation value for the point in road network model 106 using elevation values associated with the identified intersections. As noted above, the interpolating can be performed when the point's elevation value is unavailable in elevation model 104 due to one or more non-terrain features (e.g., vegetation) overlapping the point and preventing measurement of the point's elevation value. For example, FIG. 3A illustrates road network 302 that has been obscured by surrounding vegetation 304. Because vegetation 304 partially overlaps regions of road network 302, elevation values of several road points on road network 302 cannot be measured using conventional satellite or aerial imaging techniques. The elevation values which have not been measured (and are thus unavailable in elevation model 104) are interpolated as interpolated elevation values 108 by elevation interpolator 130.

In an embodiment, road traversal engine 120 traverses road paths and elevation interpolator 130 interpolates elevations for each road point on road network model 106.

In this way, by determining interpolated elevation values 108 for points whose elevation values are unavailable in elevation model 104, embodiments generate a complete elevation model that can be used to render appropriately elevated features (e.g., road networks) to improve user viewing experience. Furthermore, such a complete interpolated elevation model can also be used to generate accurate routes (e.g., bicycle routes) where terrain gradation is a consideration.

In an embodiment, road traversal engine 120 and elevation interpolator 130 can each be any type of processing (or computing) device having one or more processors and memory for storage. For example, road traversal engine 120 and elevation interpolator 130 can each be implemented as a workstation, mobile device (such as a mobile phone tablet or laptop), computer, cluster of computers, set-top box, embedded system, console, or other device having at least one processor. Such a processing device may include software, firmware, hardware, or a combination thereof. Software may include one or more applications and an operating system. Hardware can include, but is not limited to, a processor, memory and graphical user interface display.

In an embodiment, road traversal engine 120 and elevation interpolator 130 can be implemented at a server that provides data over a network to one or more clients that render geographic terrain for display to a user. In another non-limiting embodiment, road traversal engine 120 and elevation interpolator 130 may also be implemented at one or more clients that retrieve road network model 106 and elevation model 104 from a server over a network. In yet another embodiment, operations performed by road traversal engine 120 and elevation interpolator 130 may be distributed across a plurality of computers and servers included in a cloud computing infrastructure.

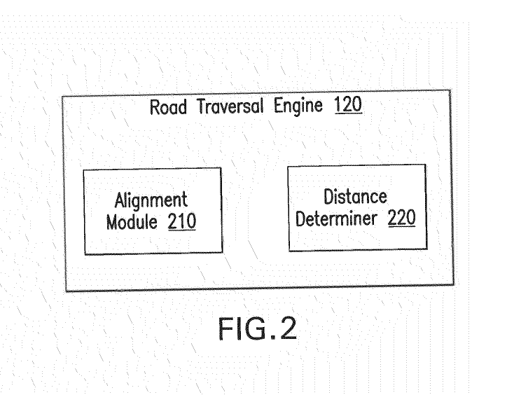

FIG. 2 illustrates road traversal engine 120, according to an embodiment. As shown in FIG. 2, road traversal engine 120 includes alignment module 210 and distance determiner 220.

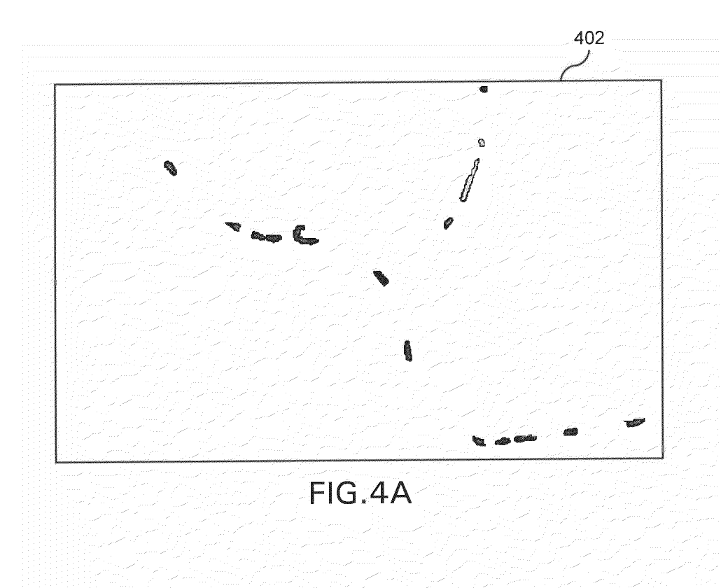

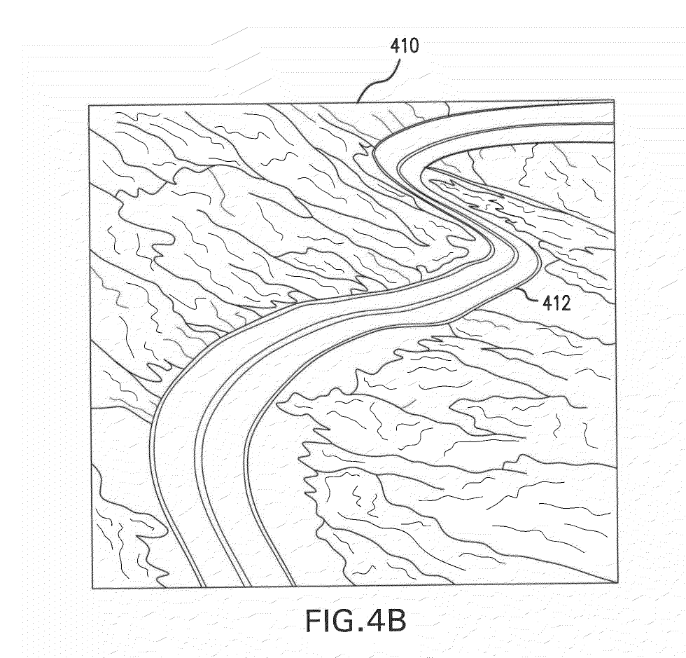

In an embodiment, alignment module 210 is configured to align road network model 106 with elevation model 104 (or vice versa). For example, as shown in FIG. 3D alignment module 210 can align road network 302 of FIG. 3C with elevation model 306 of FIG. 3B. The alignment shown in FIG. 3D illustrates those elevation values from FIG. 3B that correspond to the road network of FIG. 3C. These corresponding elevation values are also illustrated independently in FIG. 4A.

FIG. 3D is purely illustrative and not intended to limit the embodiments. Embodiments are not limited to ‘graphically’ or ‘visually’ aligning values and models, and can perform alignment by determining correspondences between data values directly from road network model 106 and elevation model 104.

In an embodiment, by aligning road network model 106 with elevation model 104, alignment module 210 determines correspondences between road points in road network model 106 and elevation values in elevation model 104. For example, when elevation model 104 and road network model 106 are aligned, alignment module 210 determines which road points correspond to elevation values in elevation model 104. For example, alignment module 210 may determine that one point is associated with an elevation value, while a second point is not associated with an elevation value. The second point may not have a corresponding elevation value in elevation model 104 due to one or more non-terrain features (e.g., vegetation) overlapping the second point and preventing measurement of the point's elevation value into elevation model 104. Elevation interpolator 130 can interpolate and determine an interpolated elevation value for the second point, according to an embodiment.

For example, referring to FIG. 3D, road points 310 and 312 correspond to regions having measured elevation values. However, road point 314 does not have an elevation value associated with itself. In an embodiment, elevation interpolator 130 can interpolate and determine an interpolated elevation value for road point 314, according to an embodiment. Such interpolation is discussed below with respect to FIG. 3D.

In an embodiment, road traversal engine 120 ‘walks out’ (or traverses paths) from every road point, following a road defined by road network model 106 till distance determiner 220 determines intersections of the traversed paths with at least two measured elevation values. In an embodiment, distance determiner 220 is configured to determine and store traversed distances from the point to each of the intersections.

Referring to FIG. 3D, for example, road traversal engine 120 traverses road paths from point 314 in all available directions to determine intersections of the traversed paths with at least two measured elevation values. In an embodiment, road traversal engine 120 traverses road paths outwards from point 314 in all available directions in parallel. For example, road traversal engine 120 traverses path 316 from point 314 to point 310 while road traversal engine 120 is also traversing path 318 to point 312.

In this example, intersections are determined by road traversal engine 120 at points 310 and 312 because points 310 and 312 correspond to regions having measured elevation values and therefore points 310 and 312 have elevation values associated with themselves. 316 also represents the distance traversed by road traversal engine 120 until the traversed path intersects with an elevation value of point 310. Similarly, 318 also represents the distance traversed by road traversal engine 120 until the traversed path intersects with an elevation value of point 312.

In an embodiment, traversed distances (e.g., 316 and 318) are stored by distance determiner 220. In an embodiment, elevation interpolator 130 determines an interpolated elevation value for point 314 as a function of traversed distances 316 and 318 as well as measured elevation values associated with points 310 and 312. As noted above, elevation values associated with points 310 and 312 are available in elevation model 104.

In an embodiment, elevation interpolator 130 interpolates elevation values for a point (e.g., point 314) where the surface is not classified as terrain (i.e., road surface). For such a point, the neighborhood of known elevation value points (e.g., 310 and 312) can serve as inputs to elevation interpolator 130 to determine an interpolated elevation value for the point, according to an embodiment.

In another example, and with reference to FIG. 3D, road traversal engine 120 traverses road paths outwards from point 322 in all available directions to determine intersections of the traversed paths with at least two measured elevation values. In an embodiment, road traversal engine 120 traverses road paths from point 322 in all available directions in parallel. For example, road traversal engine 120 traverses path 332 from point 322 to point 320 while road traversal engine 120 is also traversing path 330 to point 324. Furthermore, in an embodiment, road traversal engine 120 can traverse paths from points 314 and 322 in parallel.

In a non-limiting embodiment, road distances that are traversed from a given point by road traversal engine 120 to at least two measured elevation values may be constrained to avoid traversing distances too far, and particularly avoiding traversal through other distant points associated with their respective measured elevation values. For example, referring to FIG. 3D, elevation at point 326 does not affect an interpolated elevation value of point 314 because the traversed distances 316 and 318 are constrained to a lesser distance that does not propagate to point 326.

Furthermore, according to a non-limiting embodiment elevation values are not extrapolated, and may need a road point to only have distances to at least two measured elevation values to determine an interpolated elevation value for the road point.

It is to be appreciated that traversed distances illustrated in FIG. 3D are purely illustrative and are not intended to limit the embodiments. Embodiments can be configured to traverse any distances in parallel in all available road directions to identify intersections with any number of elevation values.

As an example, continuous road segments may share a common neighborhood of elevation values from which an elevation value can be interpolated. In an embodiment, because elevation interpolator 130 may perform interpolation over a potentially large network of roads covering the Earth, road distances (e.g., 316 and 318) can be pre-computed to avoid an O(n²) algorithm complexity in computing traversed distances from all road points for every road network in road network model 106. The “O” notation is known and used by those skilled in the art to define algorithmic complexity. In other words, by pre-computing road distances, embodiments reduce such algorithmic complexity and increase computational efficiency.

Embodiments are able to compute interpolated elevation values for a large number of road points, in parallel, using road traversal engine 120 and elevation interpolator 130, even when a large number of road networks are to be traversed. In this way, embodiments efficiently scale and parallelize operations when processing large and complex road networks.

Furthermore, road traversal engine 120 and elevation interpolator 130 can process numerous image tiles, obtained from satellite imagery, in parallel with other operations performed by road traversal engine 120 and elevation interpolator 130.

In an embodiment, elevation interpolator 130 may use an inverse distance weighted interpolation where an elevation ‘f’ for point ‘x’ with influencing points ‘w’ at distances ‘d’ is computed by elevation interpolator 130 as:

$$f ( x ) = \frac{\sum [ f ( w ) * {( d\_sum - d ( w ) )}^{p} ]}{\sum {( d\_sum - d ( w ) )}^{p}} \qquad ( 1 )$$

where,

d_sum=Σ(d(w))and p=min(1−num_weights,3)

In an embodiment, exemplary interpolation equation (1) assigns f(x) to f(w) when there is one weight, performs a one dimensional linear interpolation with two weights, a quadratic interpolation for three weights, and cubic interpolation for four or more weights. In a non-limiting embodiment, the power to cubic may be constrained to a pre-determined value in order to limit the numerical range of factors in computation and thus increase computational efficiency.

It is to be appreciated that the embodiments are not limited to exemplary interpolation equation (1) and can use any other form of interpolation, including, but not limited to Lagrange interpolation and any variations thereof. Lagrange interpolation is well known to those skilled in the art and utilizes Lagrange polynomials for the purposes of interpolation.

FIG. 4A is diagram 402 illustrating exemplary elevation values in elevation model of FIG. 3B that correspond to road paths in the road network model of FIG. 3C, according to an embodiment. As can be seen in FIG. 4A, the elevation model is incomplete. In other words, several elevation values that should correspond to road points of FIG. 3C are missing from the elevation model of FIG. 4A. These missing values are more apparent when FIG. 4A is aligned with FIG. 3C as shown in FIG. 3D.

When a road surface (or road “deck”) is rendered for display using the elevation model of FIG. 4A, the road surface is incorrectly elevated as shown in rendered view 410 of FIG. 4B. Particularly, graded road surface 412 is rendered that is inconsistent with a level road surface because the rendered road surface 412 simply follows neighboring terrain gradations of the mountains and the hillsides. In other words, road surface 412 is rendered with a bank that follows neighboring terrain gradations. Such rendering artifacts degrade a user's map viewing experience (or satellite view). These artifacts are apparent in rendered view 410 because the road surface 412 follows the gradations (or slope) of the surrounding terrain.

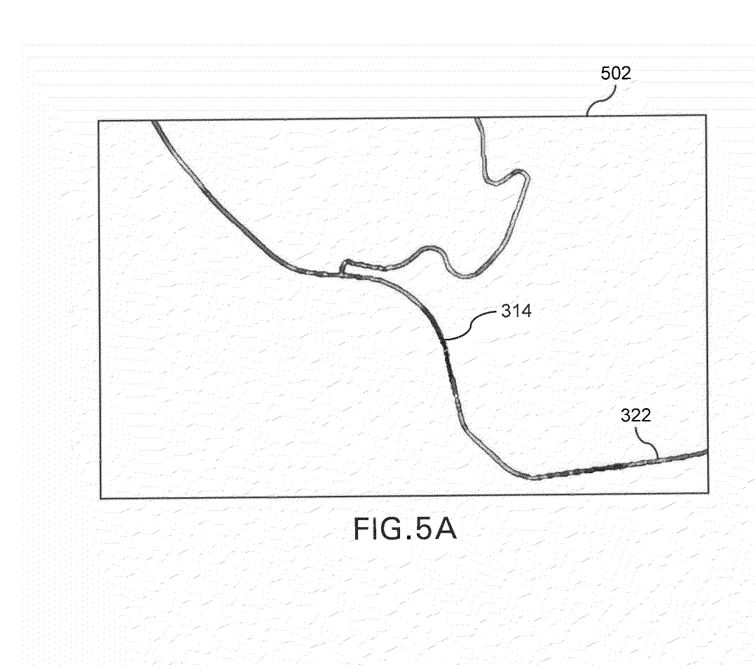

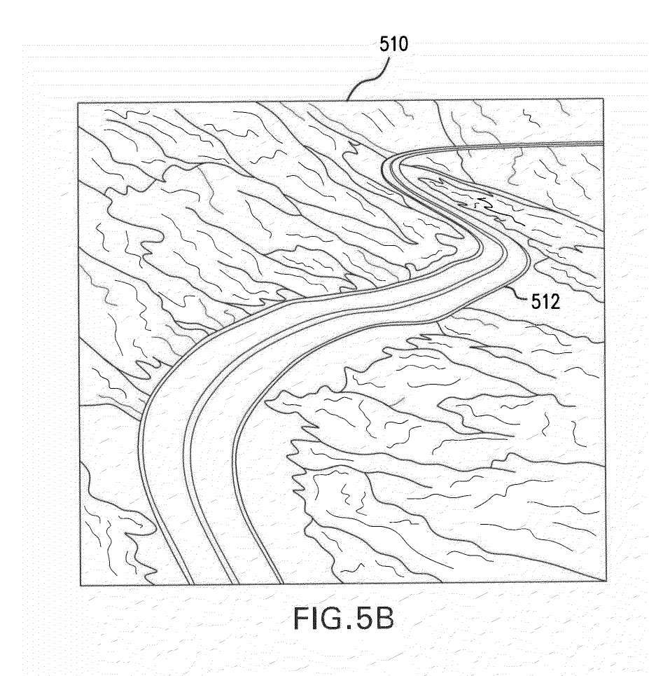

FIG. 5A is a diagram illustrating an output elevation model 502 including interpolated elevation values 314 and 322 corresponding to the road network model of FIG. 3C, according to an embodiment. As shown in FIG. 5A, elevation values for all points (including points 314 and 322) corresponding to the road network model of FIG. 3C have been interpolated by elevation interpolator 130. When a road surface (or road “deck”) is rendered for display using the elevation model of FIG. 5A, the road surface is appropriately elevated as shown in rendered view 510 of FIG. 5B. Particularly, a graded road surface 512 is rendered that is consistent with a level road surface because the rendered road surface 512 does not simply follow neighboring terrain gradations of the mountains and the hillsides. Instead, road surface 512 is rendered in accordance with interpolated elevation values determined by elevation interpolator 130.

In this way, by determining interpolated elevation values for points for whom elevation values are unavailable, embodiments generate a complete elevation model that can be used to render appropriately elevated features (e.g., road networks) to improve user viewing experience. Furthermore, such a complete interpolated elevation model can also be used to generate accurate routes (e.g., bicycle routes) where terrain gradation is a consideration.

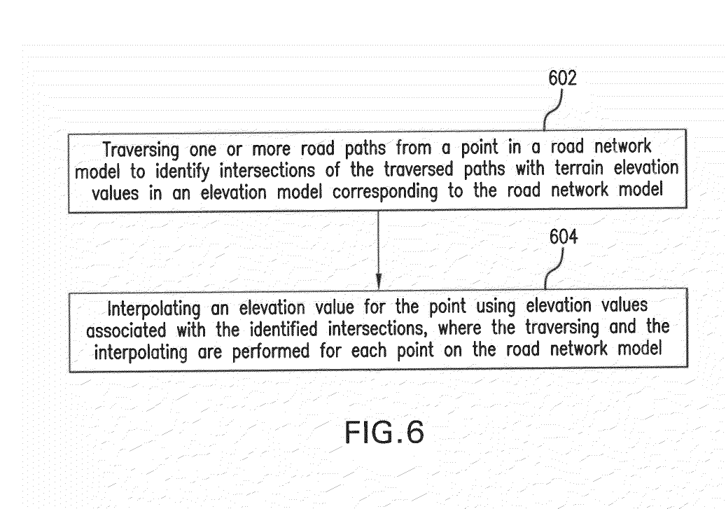

FIG. 6 illustrates method 600, which is an exemplary overall operation, according to an embodiment.

Method 600 begins with traversing one or more road paths from a point in a road network model to identify intersections of the traversed paths with terrain elevation values in an elevation model corresponding to the road network model (step 602). As an example, road traversal engine 120 may traverse road paths 316 and 318 from point 314 to identify intersections of the traversed paths 316 and 318 with terrain elevation values in elevation model 104 corresponding to road network model 106.

Method 600 proceeds by interpolating an elevation value for the point using elevation values associated with the identified intersections, wherein the traversing and the interpolating are performed for each point on the road network model (step 602). As an example, elevation interpolator 130 can interpolate an elevation value for point 314 using elevation values associated with the identified intersections 310 and 312. Furthermore, in an embodiment, steps 600 and 602 are performed for each point on the road network model. For example, steps 600 and 602 may be used to determine an elevation value for point 322 using elevations associated with points 324 and 320.

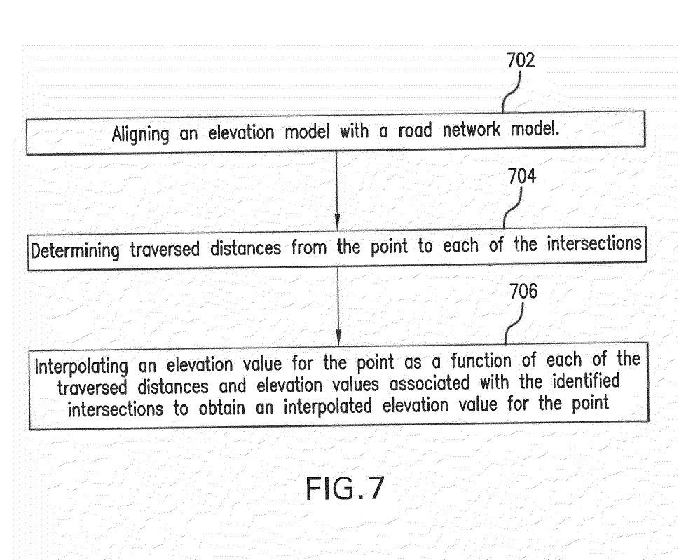

FIG. 7 illustrates method 700, which is an exemplary interpolating operation, according to an embodiment.

Method 700 begins with aligning an elevation model with a road network model (step 702). As an example, road network model 106 can be aligned with elevation model 104 by alignment module 210. Method 700 proceeds by determining traversed distances from the point to each of the intersections (step 704). As an example, road traversal engine 120 may traverse road paths 316 and 318 from point 314 to identify intersections 310 and 312 of the traversed paths 316 and 318 with terrain elevation values in elevation model 104 corresponding to road network model 106. Traversed road distances 316 and 318 can be determined and stored by distance determiner 220.

The elevation value for the point is interpolated as a function of each of the traversed distances and the elevation values associated with the identified intersections to obtain an interpolated elevation value for the point (step 706). As an example, an interpolated elevation value 108 is determined for point 314, where interpolated elevation value 108 is a function of traversed distances 316 and 318 and elevation values associated with points 310 and 312. In an embodiment, the interpolating is performed when point 314's elevation value is unavailable in elevation model 104 due to one or more non-terrain features (e.g., vegetation) overlapping point 314 and preventing measurement of the point 314's elevation value.

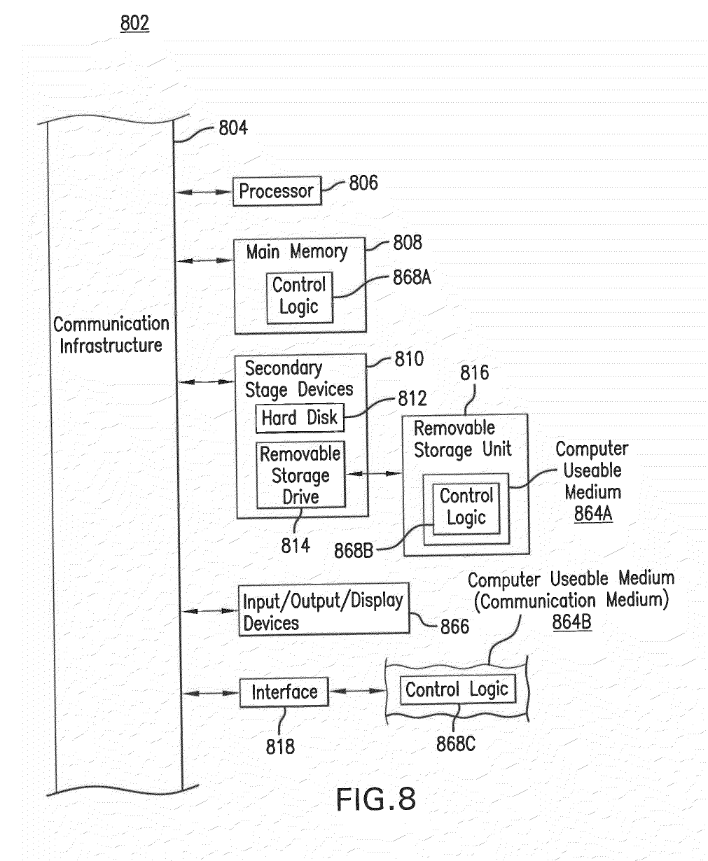

In an embodiment, the system, methods and components of embodiments described herein are implemented using one or more computers, such as example computer 802 shown in FIG. 8. For example, road traversal engine 120, elevation interpolator 130, alignment module 210 and distance determiner 220 can be implemented using computer(s) 802.

Computer 802 can be any commercially available and well known computer capable of performing the functions described herein, such as computers available from International Business Machines, Apple, Oracle, HP, Dell, Cray, etc.

Computer 802 includes one or more processors (also called central processing units, or CPUs), such as a processor 806. Processor 806 is connected to a communication infrastructure 804.

Computer 802 also includes a main or primary memory 808, such as random access memory (RAM). Primary memory 808 has stored therein control logic 868A (computer software), and data.

Computer 802 also includes one at more secondary storage devices 810. Secondary storage devices 810 include, for example, a hard disk drive 812 and/or a removable storage device or drive 814, as well as other types of storage devices, such as memory cards and memory sticks. Removable storage drive 814 represents a floppy disk drive, a magnetic tape drive, a compact disk drive, an optical storage device, tape backup, etc.

Removable storage drive 814 interacts with a removable storage unit 816. Removable storage unit 816 includes a computer useable or readable storage medium 864A having stored therein computer software 868B (control logic) and/or data. Removable storage unit 816 represents a floppy disk, magnetic tape, compact disk, DVD, optical storage disk, or any other computer data storage device. Removable storage drive 814 reads from and/or writes to removable storage unit 816 in a well-known manner.

Computer 802 also includes input/output/display devices 866, such as monitors, keyboards, pointing devices, Bluetooth devices, etc.

Computer 802 further includes a communication or network interface 818. Network interface 818 enables computer 802 to communicate with remote devices. For example, network interface 818 allows computer 802 to communicate over communication networks or mediums 864B (representing a form of a computer useable or readable medium), such as LANs, WANs, the Internet, etc. Network interface 818 may interface with remote sites or networks via wired or wireless connections.

Control logic 868C may be transmitted to and from computer 802 via communication medium 864B.

Any tangible apparatus or article of manufacture comprising a computer useable or readable medium having control logic (software) stored therein is referred to herein as a computer program product or program storage device. This includes, but is not limited to, computer 802, main memory 808, secondary storage devices 810 and removable storage unit 816. Such computer program products, having control logic stored therein that, when executed by one or more data processing devices, cause such data processing devices to operate as described herein, represent the embodiments.

Embodiments can work with software, hardware, and/or operating system implementations other than those described herein. Any software, hardware, and operating system implementations suitable for performing the functions described herein can be used. Embodiments are applicable to both a client and to a server or a combination of both.

The Summary and Abstract sections may set forth one or more but not all exemplary embodiments as contemplated by the inventor(s), and thus, are not intended to limit the present embodiments and the appended claims in any way.

The present embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the embodiments that others can, by applying knowledge within the skill of the art, readily modify and/or adapt for various applications such specific embodiments, without undue experimentation, without departing from the general concept of the present embodiments. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present embodiments should not be limited by any of the above-described exemplary embodiments, but should be defined only in accordance with the following claims and their equivalents.

1. A computer implemented method, comprising:
receiving, by one or more computing devices, a road network model including data specifying road locations in one or more geographical regions and an elevation model including terrain elevation values of terrain representing the surface of the Earth;
identifying, by the one or more computing devices, a point in the road network model having an elevation value that is unavailable in the elevation model;
traversing, by the one or more computing devices, one or more road paths from the point in the road network model to identify intersections of the traversed road paths with terrain elevation values in the elevation model corresponding to the road network model; and
interpolating, by the one or more computing devices, an elevation value for the point using elevation values associated with the identified intersections, wherein the traversing and the interpolating are performed for each point on the road network model.

2. The method of claim 1, wherein the traversing is performed for a pre-determined distance along the road paths.

3. The method of claim 1, further comprising:
aligning, by the one or more computing devices, the elevation model with the road network model.

4. The method of claim 1, further comprising:
determining, by the one or more computing devices, traversed distances from the point to each of the intersections.

5. The method of claim 4, the interpolating comprising:
interpolating the elevation value for the point as a function of each of the traversed distances and the elevation values associated with the identified intersections to obtain an interpolated elevation value for the point, the interpolating performed when the point's elevation value is unavailable in the elevation model due to one or more non-terrain features overlapping the point and preventing measurement of the point's elevation value.

6. A computer-based system, comprising:
one or more processors configured to receive a road network model including data specifying road locations in one or more geographical regions and an elevation model including terrain elevation values of terrain representing the surface of the Earth, and to identify a point in the road network model having an elevation value that is unavailable in the elevation model;
a road traversal engine configured to traverse one or more road paths from the point in the road network model to identify intersections of the traversed road paths with terrain elevation values in the elevation model corresponding to the road network model; and
an elevation interpolator configured to interpolate an elevation value for the point using elevation values associated with the identified intersections, wherein the road traversal engine traverses road paths and the elevation interpolator interpolates elevations for each point on the road network model, and wherein the traversing and the interpolating are implemented using the one or more processors.

7. The system of claim 6, further comprising an alignment module configured to align the elevation model with the road network model.

8. The system of claim 6, further comprising a distance determiner configured to determine traversed distances from the point to each of the intersections.

9. The system of claim 6, wherein the elevation interpolator is configured to interpolate the elevation value for the point as a function of each of the traversed distances and the elevation values associated with the identified intersections to obtain an interpolated elevation value for the point, the interpolating performed when the point's elevation value is unavailable in the elevation model due to one or more non-terrain features overlapping the point and preventing measurement of the point's elevation value.

10. The system of claim 6, wherein the point is a road terrain pixel.

11. A non-transitory computer storage apparatus encoded with a computer program, the program comprising instructions that when executed by data processing apparatus cause the data processing apparatus to perform operations, comprising:
receiving a road network model including data specifying road locations in one or more geographical regions and an elevation model including terrain elevation values of terrain representing the surface of the Earth;
identifying a point in the road network model having an elevation value that is unavailable in the elevation model;
traversing one or more road paths from the point in the road network model to identify intersections of the traversed road paths with terrain elevation values in the elevation model corresponding to the road network model; and
interpolating an elevation value for the point using elevation values associated with the identified intersections, wherein the traversing and the interpolating are performed for each point on the road network model.

12. The computer storage apparatus of claim 11, wherein the traversing is performed for a pre-determined distance along the road paths.

13. The computer storage apparatus of claim 11, the operations further comprising:
aligning the elevation model with the road network model.

14. The computer storage apparatus of claim 11, the operations further comprising:
determining traversed distances from the point to each of the intersections.

15. The computer storage apparatus of claim 11, the interpolating comprising:
interpolating the elevation value for the point as a function of each of the traversed distances and the elevation values associated with the identified intersections to obtain an interpolated elevation value for the point, the interpolating performed when the point's elevation value is unavailable in the elevation model due to one or more non-terrain features overlapping the point and preventing measurement of the point's elevation value.
